(19) United States
(12) Patent Application Publication
(10) Pub. No.: US 2026/0302481 A1
(43) Pub. Date: Oct. 1, 2026

(54) BATTERY MODULE

(71) Applicant: HONDA MOTOR CO., LTD., Tokyo (JP)

(72) Inventors: Yuta KAGEI, Saitama (JP); Hideki MATSUDA, Saitama (JP); Hidemasa USUI, Saitama (JP)

(21) Appl. No.: 19/635,520

(22) Filed: Mar. 31, 2026

(30) Foreign Application Priority Data
Mar. 31, 2025 (JP) 2025-059535

(51) Int. Cl. H01M 50/242; H01M 10/0525; H01M 50/204; H01M 50/291

(52) U.S. Cl. CPC H01M 50/242; H01M 10/0525; H01M 50/204; H01M 50/291

(57) ABSTRACT

Provided is a battery module including a battery cell stack in which a plurality of battery cells are stacked, and an elastic member disposed between the plurality of battery cells. The elastic member includes a pouch in which a gas and a wave-shaped leaf spring are sealed.

This application is based on and claims the benefit of priority from Japanese Patent Application No. 2025-059535, filed on 31 Mar. 2025, the content of which is incorporated herein by reference.

### BACKGROUND OF THE INVENTION

### Field of the Invention

The present invention relates to a battery module.

### Related Art

In recent years, research and development has been conducted on battery modules that contribute to energy efficiency in order to ensure that more people have access to affordable, reliable, sustainable, and advanced energy.

Japanese Unexamined Patent Application, Publication No. 2003-303579 discloses a module containing a flat secondary battery. At this time, the module is formed by disposing a fluid-containing bag hermetically containing a fluid between a module outer casing for pressurizing and fixing the flat secondary battery and the flat secondary battery.
Patent Document 1: Japanese Unexamined Patent Application, Publication No. 2003-303579

### SUMMARY OF THE INVENTION

However, when the fluid-containing bag disclosed in Japanese Unexamined Patent Application, Publication No. 2003-303579 is disposed between a plurality of battery cells, the battery cells expand and contract as they are charged and discharged, making the fluid-containing bag prone to damage.

An object of the present invention is to provide a battery module capable of suppressing a reduction in the elasticity of an elastic member even when a pouch is damaged.

A first aspect of the present invention is a battery module including: a battery cell stack in which a plurality of battery cells are stacked; and an elastic member disposed between the plurality of battery cells. The elastic member includes a pouch in which a gas and a wave-shaped leaf spring are sealed.

In a second aspect of the present invention according to the first aspect, the wave-shaped leaf spring has an inorganic material content of 70% by mass or more.

In a third aspect of the present invention according to the first or second aspect, the wave-shaped leaf spring includes fiber reinforced plastic.

In a fourth aspect of the present invention according to any one of the first to third aspects, the pouch has an internal pressure of 0.1 MPa or more and 3.0 MPa or less.

In a fifth aspect of the present invention according to any one of the first to fourth aspects, the elastic member further includes elastic foam bodies respectively disposed on both sides of the pouch in a stacking direction of the battery cells.

In a sixth aspect of the present invention according to any one of the first to fifth aspects, the battery cells each include a cell including a negative electrode material mixture layer including lithium metal or a lithium alloy.

In a seventh aspect of the present invention according to any one of the first to sixth aspects, the battery cells each include a solid-state battery cell.

According to the present invention, it is possible to provide a battery module capable of suppressing a reduction in the elasticity of an elastic member even when a pouch is damaged.

### BRIEF DESCRIPTION OF THE DRAWINGS

FIG. 1 is a side view showing a battery module according to an embodiment of the present invention;

FIG. 2A is a partially enlarged perspective view of the battery module of FIG. 1;

FIG. 2B is a schematic diagram showing a cross section taken along line A-A of FIG. 2A;

FIG. 2C is a schematic diagram showing a cross section taken along line B-B of FIG. 2A; and

FIG. 3 is a partially enlarged schematic view of an elastic member of FIG. 2B.

### DETAILED DESCRIPTION OF THE INVENTION

Hereinafter, embodiments of the present invention will be described with reference to the drawings.

### Battery Module

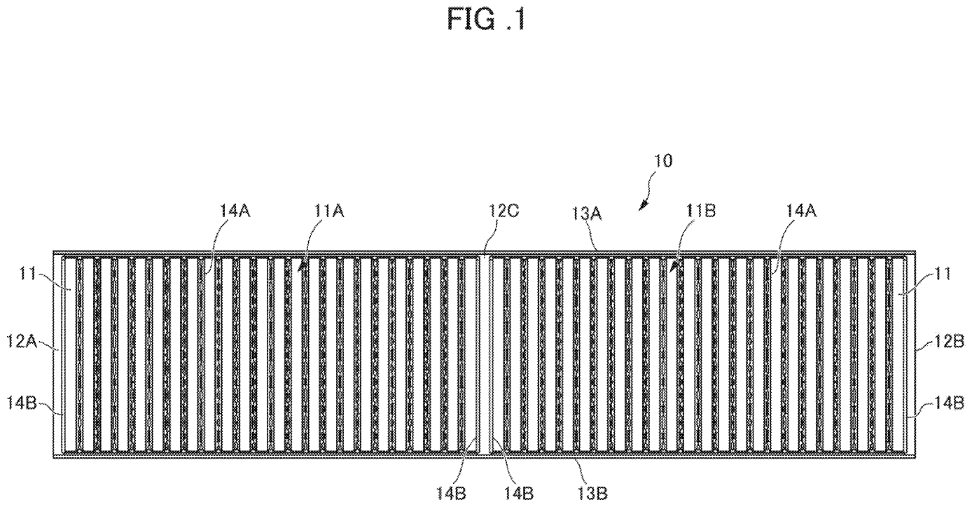

FIG. 1 shows a battery module according to an embodiment of the present invention.

A battery module 10 includes battery cell stacks 11A and 11B each including a plurality of battery cells 11 stacked, end plates 12A and 12B respectively provided at both end portions of the battery cell stacks 11A and 11B in the stacking direction, and a center plate 12C provided between the battery cell stacks 11A and 11B. The battery module 10 also includes binding bars 13A and 13B for restraining the battery cell stacks 11A and 11B between the end plates 12A and 12B. The restraining pressure by the binding bars 13A and 13B is not particularly limited, but is, for example, 1.0 MPa or more and 2.5 MPa or less.

In the battery module 10, an elastic member 14A is disposed between each of the plurality of battery cells 11, and elastic members 14B are respectively disposed between the battery cell stack 11A and the end plate 12A, between the battery cell stack 11A and the center plate 12C, between the battery cell stack 11B and the end plate 12B, and between the battery cell stack 11B and the center plate 12C. At this time, since the elastic member 14B is in contact with one battery cell 11, it is not particularly limited as long as it has approximately half or more of the elasticity of the elastic member 14A in contact with two battery cells 11. The elastic member 14B preferably has the same configuration as that of the elastic member 14A except that the thickness is approximately half from the viewpoint of the energy density of the battery module 10, but may be identical to the elastic member 14A.

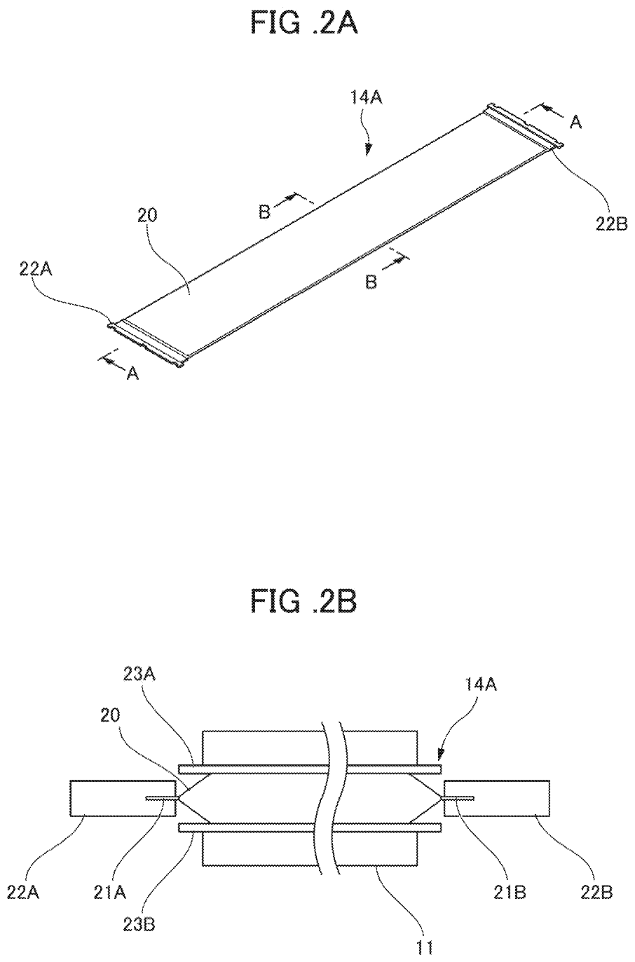

As shown in FIGS. 2A, 2B, and 2C, the elastic member 14A includes a pouch 20 in which a gas is sealed, and elastic foam bodies 23A and 23B respectively disposed on both sides of the pouch 20 in the stacking direction of the battery cells 11. At this time, when the elastic member 14A is compressed along with the expansion of the battery cells 11 during charging, since the elastic foam bodies 23A and 23B are interposed between the battery cells 11 and the pouch 20, the uniformity of the surface pressure of the elastic member 14A is increased. In FIG. 2A, the battery cells 11 and the elastic foam bodies 23A and 23B are omitted.

The internal pressure of the pouch 20 is preferably 0.1 MPa or more and 3.0 MPa or less, and more preferably 1.0 MPa or more and 2.5 MPa or less. When the internal pressure of the pouch 20 is 0.1 MPa or more, the uniformity of the surface pressure of the elastic member 14A is increased, and when the internal pressure is 3.0 MPa or less, even if the battery cells 11 expand and contract along with charging and discharging of the battery cells 11, damage to the pouch 20 is suppressed.

As shown in FIG. 2B, the pouch 20 includes a first sealing part 21A and a second sealing part 21B at both end portions, respectively, thereof in a direction (A-A direction) perpendicular to the stacking direction of the battery cells 11. As shown in FIG. 2C, the pouch 20 includes a third sealing part 21C extending in the direction (A-A direction) perpendicular to the stacking direction of the battery cells 11, and the third sealing part 21C is in contact with the elastic foam body 23B.

At this time, the elastic member 14A further includes a first support member 22A that supports substantially the entire area of the first sealing part 21A, and a second support member 22B that supports substantially the entire area of the second sealing part 21B. The first support member 22A and the second support member 22B are positioned by, for example, a positioning member installed in the battery module 10.

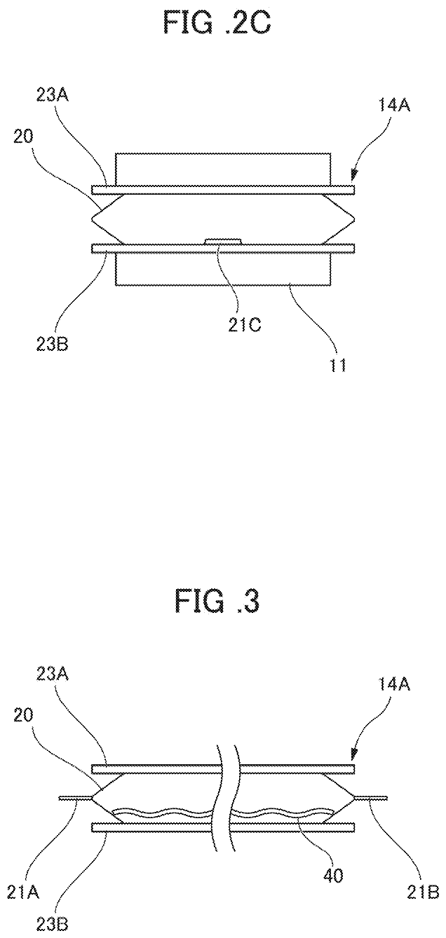

As shown in FIG. 3, a wave-shaped leaf spring 40 together with the gas are sealed in the pouch 20. Therefore, even when the pouch 20 is damaged, a reduction in the elasticity of the elastic member 14A is suppressed.

The content of the inorganic material in the wave-shaped leaf spring 40 is preferably 70% by mass or more, and more preferably 80% by mass or more. When the content of the inorganic material in the wave-shaped leaf spring 40 is 70% by mass or more, the heat resistance of the wave-shaped leaf spring 40 is improved, and as a result, even when the pouch 20 is damaged, the damage to the wave-shaped leaf spring 40 due to the heat generation of the battery cell 11 is suppressed. The inorganic material is not particularly limited, and examples thereof include a carbon material and a glass material. Among these, a carbon material is preferable from the viewpoint of heat resistance.

The wave-shaped leaf spring 40 preferably includes fiber reinforced plastic (FRP). As a result, both the heat resistance and the heat insulation properties of the wave-shaped leaf spring 40 are achieved. Examples of the FRP include carbon fiber reinforced plastic (CFRP) and glass fiber reinforced plastic (GFRP).

The wave-shaped leaf spring 40 is produced by, for example, a press molding method.

Here, the number of the wave-shaped leaf springs 40 sealed in the pouch 20 is not particularly limited. Instead of the wave-shaped leaf spring 40, a stack in which a plurality of wave-shaped leaf springs 40 are stacked may be used.

The pouch 20 is not particularly limited as long as it has stretchability that can follow the expansion and contraction accompanying the charging and discharging of the battery cells 11 and it is capable of sealing. For example, the pouch 20 may be a pouch in which an aluminum film is sandwiched between stretchable resin films. The stretchable resin is not particularly limited, and examples thereof include polypropylene, polyamide, and polyester.

The method for forming the first sealing part 21A, the second sealing part 21B, and the third sealing part 21C is not particularly limited, and examples thereof include a method of thermally fusing the stretchable resin constituting the pouch 20.

The pouch 20 is not particularly limited, and examples thereof include a pillow pouch (commercially available product). The gas sealed in the pouch 20 is not particularly limited, and examples thereof include air.

Instead of the pouch 20, a pouch including the first sealing part 21A and the second sealing part 21B at both end portions, respectively, in the direction (A-A direction) perpendicular to the stacking direction of the battery cells 11 and including a sealing part other than the third sealing part 21C may be used.

The material constituting the first support member 22A and the second support member 22B is not particularly limited, and examples thereof include a resin and a metal.

The Poisson's ratio of the elastic foam bodies 23A and 23B is preferably 0.3 or less. When the Poisson's ratio of the elastic foam bodies 23A and 23B is 0.3 or less, the elastic foam bodies 23A and 23B easily absorb changes in thickness accompanying expansion and contraction of the battery cells 11. The Poisson's ratio of the elastic foam bodies 23A and 23B is, for example, 0.01 or more.

The thickness of the elastic foam bodies 23A and 23B when the state of charge of the battery cells is 100% is not particularly limited, but is, for example, 0.05 mm or more and 0.1 mm or less.

The porosity of the elastic foam bodies 23A and 23B is not particularly limited, but is, for example, 30% or more and 95% or less. The material constituting the elastic foam bodies 23A and 23B is not particularly limited, and examples thereof include polyurethane, silicone resin, ethylene propylene rubber, styrene resin, olefin resin, polyamide, and polyester.

The method for fixing the elastic foam body 23A (or 23B) to the pouch 20 is not particularly limited, and examples thereof include a method of bonding the elastic foam body 23A (or 23B) to the pouch 20 with an elastic adhesive.

### Cell

The cell constituting the battery cell 11 is not particularly limited, and examples thereof include a solid-state battery cell such as an all-solid-state battery cell or a semi-solid-state battery cell, and a nonaqueous electrolyte battery cell including a negative electrode material mixture layer containing lithium metal or a lithium alloy. An element other than lithium constituting the lithium alloy is not particularly limited, and examples thereof include Sn, Ag, Mg, In, Si, and Al. Among these, from the viewpoint of energy density, a solid-state battery cell including a negative electrode material mixture layer containing lithium metal or a lithium alloy is preferable.

Hereinafter, an example of the all-solid-state battery cell will be described.

The all-solid-state battery cell includes a negative electrode current collector, a negative electrode material mixture layer containing lithium metal or a lithium alloy, a solid electrolyte layer, a positive electrode material mixture layer, and a positive electrode current collector.

The material constituting the negative electrode current collector is not particularly limited, and examples thereof include silver, palladium, gold, platinum, aluminum, copper, nickel, stainless steel, and carbon. Among these, copper, stainless steel, and nickel are preferable from the viewpoints of conductivity and cost.

The shape of the negative electrode current collector is not particularly limited, and examples thereof include a foil shape, a plate shape, a mesh shape, a nonwoven fabric shape, and a foamed shape.

The solid electrolyte constituting the solid electrolyte layer is not particularly limited, and examples thereof include a sulfide solid electrolyte and an oxide solid electrolyte.

The form of the solid electrolyte is not particularly limited, and examples thereof include particles.

The content of the solid electrolyte in the solid electrolyte layer is not particularly limited, but is, for example, 50% by mass or more and 99% by mass or less.

The solid electrolyte layer may further contain a binder, etc.

The method for forming the solid electrolyte layer is not particularly limited, and examples thereof include a method of applying a slurry containing a solid electrolyte and a solvent.

The positive electrode material mixture layer contains a positive electrode active material. Examples of the positive electrode active material is not particularly limited, and examples thereof include lithium cobalt oxide (LiCoO₂), lithium nickel oxide (LiNiO₂), LiNiₚMn_{q}CoᵣO₂ (p+q+r=1), LiNiₚAl_{q}CoᵣO₂ (p+q+r=1), lithium manganate (LiMn₂O₄), Li₁₊ₓMn_{2-x-y}M_{y}O₄ (x+y=2) (where M is one or more elements selected from the group consisting of Al, Mg, Co, Fe, Ni, and Zn), lithium titanate, and LiMPO₄ (where M is one or more elements selected from the group consisting of Fe, Mn, Co, and Ni).

The content of the positive electrode active material in the positive electrode material mixture layer is not particularly limited, but is, for example, 50% by mass or more and 99% by mass or less.

The positive electrode material mixture layer may further contain a solid electrolyte. The solid electrolyte is not particularly limited as long as it can conduct lithium ions, and examples thereof include an oxide solid electrolyte and a sulfide solid electrolyte.

The positive electrode material mixture layer may further contain a binder, a conductivity aid, etc. is not particularly

[symbol]

The method for forming the positive electrode material mixture layer is not particularly limited, and examples thereof include a method of applying a slurry containing a positive electrode active material and a solvent.

The material constituting the positive electrode current collector is not particularly limited, and examples thereof include aluminum, an aluminum alloy, stainless steel, nickel, iron, and titanium. Among these, aluminum, an aluminum alloy, and stainless steel are preferable.

The shape of the positive electrode current collector is not particularly limited, and examples thereof include a foil shape and a plate shape.

Although the embodiments of the present invention have been described above, the present invention is not limited to the above-described embodiments, and the above-described embodiments may be modified as appropriate within the scope of the gist of the present invention.

### EXPLANATION OF REFERENCE NUMERALS

10 battery module
11 battery cell
11A, 11B battery cell stack
12A, 12B end plate
12C center plate
13A, 13B binding bar
14A, 14B elastic member
20 pouch
21A first sealing part
21B second sealing part
21C third sealing part
22A first support member
22B second support member
23A, 23B elastic foam body
40 wave-shaped leaf spring

What is claimed is:

1. A battery module comprising:
a battery cell stack in which a plurality of battery cells are stacked; and
an elastic member disposed between the plurality of battery cells,
the elastic member comprising a pouch in which a gas and a wave-shaped leaf spring are sealed.

2. The battery module according to claim 1, wherein the wave-shaped leaf spring has an inorganic material content of 70% by mass or more.

3. The battery module according to claim 1, wherein the wave-shaped leaf spring comprises fiber reinforced plastic.

4. The battery module according to claim 1, wherein the pouch has an internal pressure of 0.1 MPa or more and 3.0 MPa or less.

5. The battery module according to claim 1, wherein the elastic member further comprises elastic foam bodies respectively disposed on both sides of the pouch in a stacking direction of the battery cells.

6. The battery module according to claim 1, wherein the battery cells each comprise a cell comprising a negative electrode material mixture layer comprising lithium metal or a lithium alloy.

7. The battery module according to claim 1, wherein the battery cells each comprise a solid-state battery cell.
